(19) United States
(12) Patent Application Publication
(10) Pub. No.: US 2013/0106571 A1
(43) Pub. Date: May 2, 2013

(54) APPARATUS AND METHOD FOR AUTOMATICALLY BOOTING UP ELECTRONIC DEVICE

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/590,422

(22) Filed: Aug. 21, 2012

(30) Foreign Application Priority Data
Oct. 31, 2011 (CN) 201110337718.6

(51) Int. Cl. G05B 19/00

(52) U.S. Cl. 340/5.65

(57) ABSTRACT

In a computerized method for automatically booting up an electronic device when a battery used by the electronic device is replaced, a unique Identification (ID) of the battery is detected when a battery is installed or reinstalled into a battery compartment of the electronic device. The detected unique ID is compared with a previous ID stored in a storage module of the electronic device, and a control signal is generated when the detected unique ID is different from the previous ID. When the control signal is generated, the electronic device is automatically booted up according to the control signal.

### BACKGROUND

1. Technical Field

Embodiments of the present disclosure relate to power management of electronic devices, and particularly to an apparatus and method for automatically booting up an electronic device.

2. Description of Related Art

When a battery of an electronic device, such as a smart phone or a personal digital assistant, is used up, another battery may be installed to replace the previously used battery and supply power for the electronic device. When another battery is installed, the electronic device needs to be booted up by operating a power key of the electronic device, which is somehow inconvenient. In some solutions, when a battery is detected to be installed or reinstalled, the electronic device may be automatically booted up. However, in some situations, if the installed or reinstalled battery is the same one as the previously used battery, the user may not want to immediately boot up the electronic device, for instance, when the user just wants to pull out the battery to check some information (e.g., current or voltage information) or clean dust from the electronic device after the electronic device is powered off. In contrast, when another battery for example a fully charged battery is installed to replace the previously used up battery, most of people would like to immediately boot up the electronic device. Therefore, an improved solution for automatically booting the electronic device is desired.

### BRIEF DESCRIPTION OF THE DRAWINGS

FIG. 1 illustrates a schematic structural diagram of one embodiment of an electronic device.

FIG. 2 illustrates a schematic block diagram of functional modules of a driving unit of the electronic device of FIG. 1.

FIG. 3 shows a flowchart of one embodiment of a method for automatically booting up the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

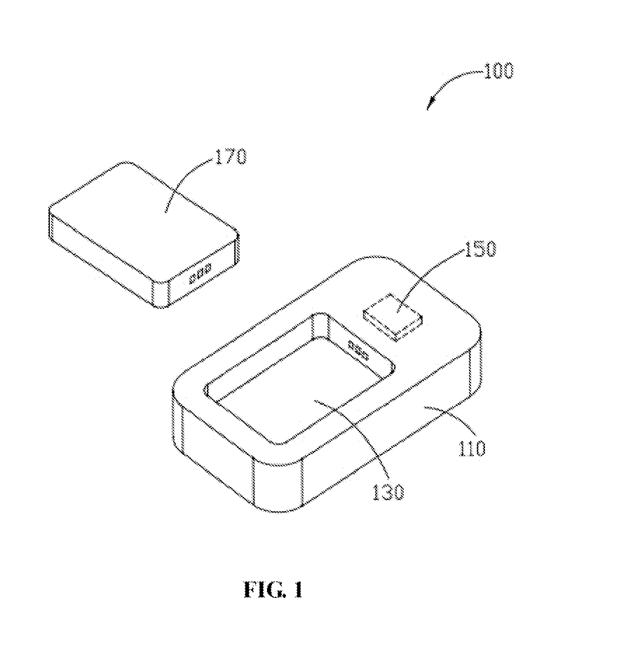

FIG. 1 is a schematic structural diagram of one embodiment of an electronic device 100. The electronic device 100 includes a main body 110, a battery compartment 130, and a driving unit 150. The battery compartment 130 is defined on the main body 110 and configured for receiving a battery (e.g., a battery 170 of FIG. 1) to provide power for the electronic device 100. The driving unit 150 is embedded into the main body 110 of the electronic device 100. In the embodiment, the electronic device 100 may be, for example, a smart phone, a personal digital assistant, a mobile Internet device, or other similar portable devices. FIG. 1 shows one example of the electronic device 100, in other embodiments, the electronic device 100 can include more or fewer components such as storage devices and processors, or have a different configuration of the components.

The driving unit 150 detects a unique identification (ID) of any battery when the battery is installed or reinstalled into the battery compartment 130, and determines whether to automatically boot up the electronic device 100 according to the detected unique ID. In the embodiment, the unique ID may be a serial number(S/N) of the battery.

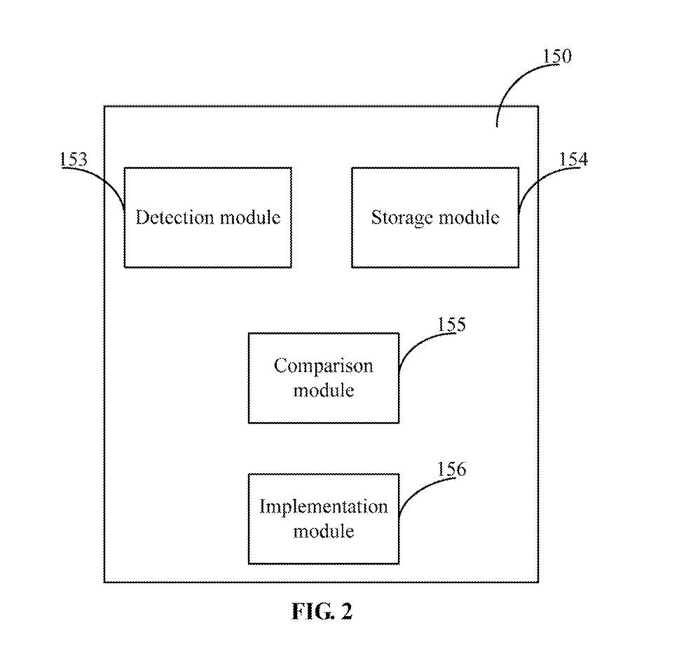

Referring to FIG. 2, is a schematic block diagram of functional modules of the driving unit 150. In the embodiment, the driving unit 150 includes a detection module 153, a storage module 154, a comparison module 155, and an implementation module 156. In general, the word “module”, as used herein, refers to logic embodied in hardware or firmware, or to a collection of software instructions, written in a programming language, such as, Java, C, or an assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memories, and hard disk drives.

The detection module 153 detects the unique ID of a battery when the battery is installed or reinstalled into the battery compartment 130. In one embodiment, the detection module 153 may be activated when a current output by the battery is detected by the driving unit 150. For example, the driving unit 150 may generate a triggering signal when the current is detected, and then activate the detection module 153 using the triggering signal.

The comparison module 155 compares the detected unique ID with a previous ID stored in the storage module 154, and generates a control signal when the detected unique ID is different from the previous ID. Additionally, the storage module 154 obtains the detected unique ID from the comparison module 155, and replaces the previous ID with the obtained unique ID. In the embodiment, the previous ID is initialized to be “null” at the first time when the battery compartment 130 receives the battery, and the detected unique ID is determined to be different from the previous ID. The previous ID is defined to be a unique ID of a battery that is previously used by the electronic device 100. It is indicated that the battery previously used by the electronic device 100 is replaced by another battery having the detected unique ID, when the detected unique ID is different from the previous ID.

The implementation module 156 boots up the electronic device 100 according to the control signal. Further, if the detected unique ID is the same as the previous ID, the implementation module 156 may boot up the electronic device 100 when a user operates a power key of the electronic device 100. In some particular conditions, the user may immediately remove the battery for other operations when the battery is installed or reinstalled. In other embodiment, the electronic device 100 may be booted up after a predetermined time period when the control signal is generated in order to avoid misoperations under the particular conditions.

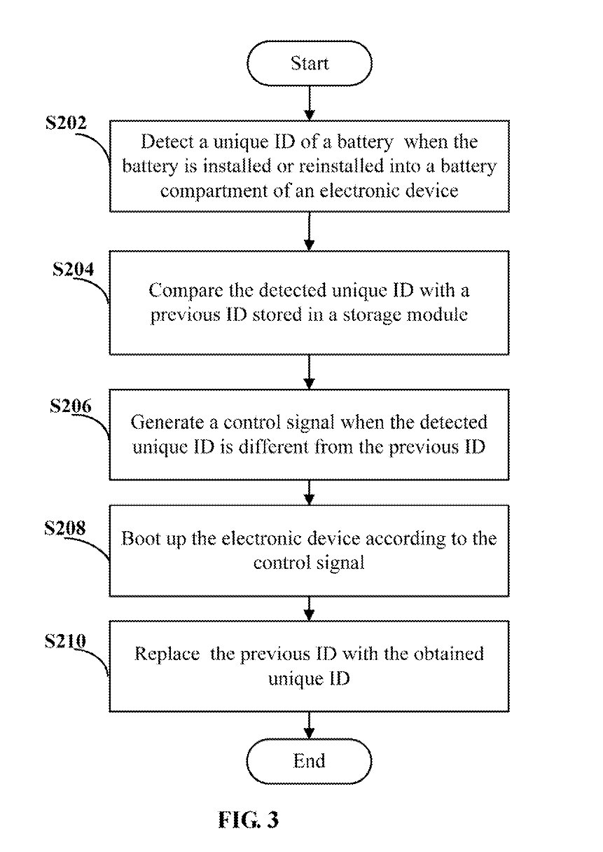

Referring to FIG. 3, a flowchart of one embodiment of a method for automatically booting up the electronic device 100 of FIG. 1 is shown. Depending on the embodiment, additional steps may be added, others removed, and the ordering of the steps may be changed.

In step S202, when a battery is installed or reinstalled into the battery compartment 130, the detection module 153 detects a unique ID of the battery. In the embodiment, the detection module 153 may be activated when a current output by the battery is detected by the driving unit 150.

In step S204, the comparison module 155 compares the detected unique ID with a previous ID stored in the storage module 154.

In step S206, the comparison module 155 generates a control signal when the detected unique ID is different from the previous ID.

In step S208, the implementation module 156 boots up the electronic device 100 according to the control signal.

In step S210, the storage module 154 obtains the detected unique ID from the comparison module 155, and replaces the previous ID with the obtained unique ID. In the embodiment, the previous ID is initialized to “null” at the first time when the battery compartment 130 receives the battery, and the detected unique ID is determined to be different from the previous ID. The previous ID is defined to be a unique ID of a battery that is previously used by the electronic device 100. It is indicated that the battery previously used by the electronic device 100 is replaced by another battery having the detected unique ID, when the detected unique ID is different from the previous ID. Thus, the electronic device 100 can be automatically booted up when the battery used by the electronic device 100 is replaced.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for automatically booting up an electronic device, the method comprising:
detecting a unique Identification (ID) of a battery when the battery is installed or reinstalled into a battery compartment of the electronic device;
comparing the detected unique ID with a previous ID stored in a storage module of the electronic device, and generating a control signal when the detected unique ID is different from the previous ID; and
booting up the electronic device according to the control signal.

2. The method according to claim 1, further comprising:
replacing the previous ID with the detected unique ID when the electronic device is booted up.

3. The method according to claim 1, wherein the unique ID of the battery is a serial number of the battery.

4. The method according to claim 1, wherein the previous ID is defined to be a unique ID of any battery that has been previously used by the electronic device.

5. The method according to claim 4, wherein the previous ID is initialized to be “null” at the first time when the battery compartment receives the battery.

6. The method according to claim 1, wherein the detecting step is activated when a current output by the battery is detected by a driving unit of the electronic device.

7. The method according to claim 1, further comprising:
booting up the electronic device a power key of the electronic device is operated upon the condition that the detected unique ID is the same as the previous ID.

8. An electronic device, comprising:
a battery compartment, and a driving unit;
the driving unit comprising:
a storage module that stores a previous Identification (ID);
a detection module that detects a unique ID of a battery when the battery is installed or reinstalled into the battery compartment;
a comparison module that compares the detected unique ID with the previous ID stored in the storage module, and generates a control signal when the detected unique ID is different from the previous ID; and
an implementation module that boots up the electronic device according to the control signal.

9. The electronic device according to claim 8, wherein the storage module further replaces the previous ID with the detected unique ID when the electronic device is booted up.

10. The electronic device according to claim 8, wherein the unique ID of the battery is a serial number of the battery.

11. The electronic device according to claim 8, wherein the previous ID is defined to be a unique ID of any battery has been previously used by the electronic device.

12. The electronic device according to claim 11, wherein the previous ID is initialized to be “null” at the first time when the battery compartment receives the battery.

13. The electronic device according to claim 8, wherein the detection module is activated when a current output by the battery is detected by the driving unit.

14. The electronic device according to claim 8, wherein the implementation module further boots up the electronic device when a power key of the electronic device is operated upon the condition that the detected unique ID is the same as the previous ID.
